(19) United States
(12) Patent Application Publication
(10) Pub. No.: US 2026/0143314 A1
(43) Pub. Date: May 21, 2026

(54) SYSTEMS AND METHODS FOR WI-FI AND C-V2X SPECTRUM SHARING

(71) Applicant: Toyota Motor Engineering & Manufacturing North America, Inc., Plano, TX (US)

(72) Inventors: Mohammad Irfan Khan, Sunnyvale, CA (US); Takayuki Shimizu, Santa Clara, CA (US); Onur Altintas, Sunnyvale, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/951,749

(22) Filed: Nov. 19, 2024

(51) Int. Cl. H04W 4/40; H04W 74/0808

(52) U.S. Cl. CPC H04W 4/40; H04W 74/0808

(57) ABSTRACT

Systems and methods for Wi-Fi and Cellular Vehicle-to-Everything (C-V2X) spectrum sharing are disclosed herein. One embodiment of a spectrum sharing system receives vehicle status information indicating whether a vehicle is parked or moving. The system also receives, from a Wi-Fi radio of the vehicle, information regarding Wi-Fi activity on a shared channel designated for both Wi-Fi and C-V2X communication. The system selects, based on the vehicle status information and the information regarding Wi-Fi activity, a mode of operation of a C-V2X radio of the vehicle and the Wi-Fi radio of the vehicle that avoids interference between Wi-Fi and C-V2X on the shared channel.

### TECHNICAL FIELD

The subject matter described herein generally relates to vehicular communication and, more particularly, to systems and methods for Wi-Fi and Cellular Vehicle-to-Everything (C-V2X) spectrum sharing.

### BACKGROUND

In 1999, the Federal Communications Commission (FCC) in the United States allocated 75 MHz of spectrum in the 5.9-GHz band for Intelligent Transport Systems (ITS). However, in 2021, 45 MHz of that reserved spectrum was taken away from ITS and reallocated for the usage of unlicensed devices, such as Wi-Fi 6. Moreover, the FCC has imposed the usage of Cellular Vehicle-to-Everything (C-V2X) technology in the ITS band. However, the remaining 30 MHz spectrum in the dedicated ITS band may not be sufficient for connected vehicles in the future.

### SUMMARY

An example of a system for Wi-Fi and Cellular Vehicle-to-Everything (C-V2X) spectrum sharing is presented herein. The system comprises a processor and a memory storing machine-readable instructions that, when executed by the processor, cause the processor to receive vehicle status information indicating whether a vehicle is parked or moving. The memory also stores machine-readable instructions that, when executed by the processor, cause the processor to receive, from a Wi-Fi radio of the vehicle, information regarding Wi-Fi activity on a shared channel designated for both Wi-Fi and C-V2X communication. The memory also stores machine-readable instructions that, when executed by the processor, cause the processor to select, based on the vehicle status information and the information regarding Wi-Fi activity, a mode of operation of a C-V2X radio of the vehicle and the Wi-Fi radio of the vehicle that avoids interference between Wi-Fi and C-V2X on the shared channel.

Another embodiment is a non-transitory computer-readable medium for Wi-Fi and C-V2X spectrum sharing and storing instructions that, when executed by a processor, cause the processor to receive vehicle status information indicating whether a vehicle is parked or moving. The instructions also cause the processor to receive, from a Wi-Fi radio of the vehicle, information regarding Wi-Fi activity on a shared channel designated for both Wi-Fi and C-V2X communication. The instructions also cause the processor to select, based on the vehicle status information and the information regarding Wi-Fi activity, a mode of operation of a C-V2X radio of the vehicle and the Wi-Fi radio of the vehicle that avoids interference between Wi-Fi and C-V2X on the shared channel.

In another embodiment, a method of Wi-Fi and C-V2X spectrum sharing is disclosed. The method comprises receiving vehicle status information indicating whether a vehicle is parked or moving. The method also includes receiving, from a Wi-Fi radio of the vehicle, information regarding Wi-Fi activity on a shared channel designated for both Wi-Fi and C-V2X communication. The method also includes selecting, based on the vehicle status information and the information regarding Wi-Fi activity, a mode of operation of a C-V2X radio of the vehicle and the Wi-Fi radio of the vehicle that avoids interference between Wi-Fi and C-V2X on the shared channel.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a vehicle in which various embodiments of the systems and methods disclosed herein can be implemented.

FIGS. 2A and 2B illustrate a spectrum sharing arrangement for Wi-Fi and Cellular Vehicle-to-Everything (C-V2X) communication, in accordance with an illustrative embodiment of the invention.

FIG. 3 is a diagram of an architecture of a spectrum sharing system, in accordance with an illustrative embodiment of the invention.

FIG. 4 is a flowchart of a mode switching process of a spectrum sharing system, in accordance with an illustrative embodiment of the invention.

FIG. 5 illustrates a configuration of a first mode (Mode A) of a spectrum sharing system, in accordance with an illustrative embodiment of the invention.

FIG. 6A illustrates a configuration of a second mode (Mode B1) of a spectrum sharing system, in accordance with an illustrative embodiment of the invention.

FIG. 6B is a flowchart of a Mode-B1 channel usage process, in accordance with an illustrative embodiment of the invention.

FIG. 7A illustrates a configuration of a third mode (Mode B2) of a spectrum sharing system, in accordance with an illustrative embodiment of the invention.

FIG. 7B is a flowchart of a Mode-B2 channel usage process, in accordance with an illustrative embodiment of the invention.

FIG. 8 illustrates a macroscopic example of Mode B2, in accordance with an illustrative embodiment of the invention.

FIG. 9 illustrates a Mode-B2 channel resource usage example, in accordance with an illustrative embodiment of the invention.

FIG. 10 is a block diagram of a spectrum sharing system, in accordance with an illustrative embodiment of the invention.

FIG. 11 is a flowchart of a method of Wi-Fi and C-V2X spectrum sharing, in accordance with an illustrative embodiment of the invention.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

Due to the limited 30-MHz bandwidth in the dedicated Intelligent Transportation Systems (ITS) band, vehicular communication may seek to coexist with Wi-Fi in the 5.9-GHz band, such as the 45 MHz previously reserved for ITS. Sharing that 45-MHz spectrum between Wi-Fi and Cellular Vehicle-to-Everything (C-V2X) communications poses some significant technical challenges, however.

First, the Physical and Medium Access Control (MAC) layers of Wi-Fi and C-V2X are completely different, which makes spectrum sharing challenging. At the MAC layer, Wi-Fi uses time divisioning of the channel to attribute transmission opportunity based on a Carrier Sense Multiple Access with Collision Avoidance (CSMA/CA) listen-before-talk mechanism. Before transmitting, a Wi-Fi device probes the channel and transmits using the full frequency of the channel for the duration of the packet airtime. During probing, if other Wi-Fi transmission or energy is detected above a predetermined threshold, the Wi-Fi device backs off before retrying. In contrast, for medium access, C-V2X divides the channel in both time (sub-frame) and frequency (sub-channel) and selects transmission resources for several future instances based on observed channel usage (i.e., packet reception and energy-level detection). These fundamental differences in channel resource division and channel access mechanism inhibit any coordinated distribution of channel access opportunity between Wi-Fi and C-V2X, resulting in simultaneous transmission and packet collisions.

Second, the physical layers of Wi-Fi and C-V2X are different. Each cannot detect (interpret, decode) the other's transmissions, thereby causing them to remain hidden from each other. During channel probing, Wi-Fi and C-V2X rely solely on sufficient energy detection, which is possible only when the stations are in close proximity. This may cause harmful interference between Wi-Fi and C-V2X communications among nodes that are farther apart.

To overcome the above challenges of spectrum sharing between Wi-Fi and C-V2X, the various embodiments described herein opportunistically use the Wi-Fi radio (in some embodiments external-facing; in others, internal) of a vehicle for smooth coexistence between Wi-Fi communication from external nodes (e.g., end users or other vehicles) and C-V2X communication from vehicles in the same shared channel. That is, the various embodiments detect external Wi-Fi activity (external Wi-Fi stations) using the co-located Wi-Fi radio of the vehicle and use that more precise information about Wi-Fi activity (i.e., information regarding the presence of Wi-Fi activity and when the external Wi-Fi stations are transmitting) to improve the C-V2X radio's usage of the shared channel.

The various embodiments include a coordination mechanism between the Wi-Fi radio of the vehicle and the C-V2X radio. The C-V2X-communication aspect uses input from the Wi-Fi radio for real-time channel probing and channel access using CSMA/CA, avoiding collision with other Wi-Fi stations. Simultaneously, the C-V2X radio monitors the channel for other vehicles' C-V2X communication and organizes its channel usage to avoid harmful interference with other C-V2X communication.

The various embodiments also include an orchestrator that orchestrates the ego vehicle's Wi-Fi communication and C-V2X communication in the shared channel based on the vehicle's contextual requirement.

Finally, the various embodiments also include a dynamic mode-switching functionality based on the vehicle's status (parked or moving) ascertained from controller-area-network (CAN) data and the presence of one or both types of communication (Wi-Fi and/or C-V2X) on the shared channel.

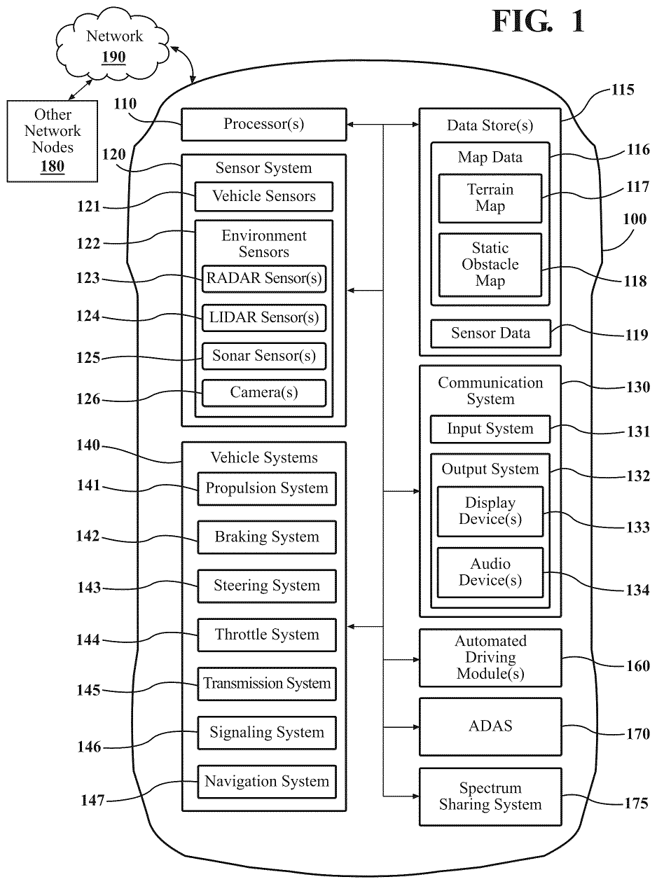

Referring to FIG. 1, it depicts a vehicle 100 in which various embodiments of a spectrum sharing system can be implemented. As used herein, a “vehicle” is any form of motorized transport. One example of a “vehicle,” without limitation, is an automobile. As shown in FIG. 1, vehicle 100 can include a spectrum sharing system 175, which is described in detail below. Hereinafter, spectrum sharing system 175 will often be referred to simply as the “system 175” for brevity. The spectrum sharing system 175 can be an aspect of a more generalized communication system of vehicle 100.

In some embodiments, vehicle 100 includes an automated driving system that enables vehicle 100 to operate in a semi-automated or automated driving mode. For example, in some embodiments, vehicle 100 can operate at a high or total level of autonomy (e.g., Society of Automotive Engineers Autonomy Levels 3-5). As indicated in FIG. 1, vehicle 100 includes automated driving module(s) 160 that implement the automated driving system. In other embodiments, vehicle 100 can operate in a semi-automated driving mode by virtue of features such as adaptive cruise-control (ACC), automatic lane-change assistance, automatic lane-keeping assistance, and automatic parking assistance. In some embodiments, such features and others (e.g., automatic collision avoidance) are aspects of an Advanced Driver-Assistance System (ADAS) 170. In still other embodiments, vehicle 100 may be driven manually by a human driver.

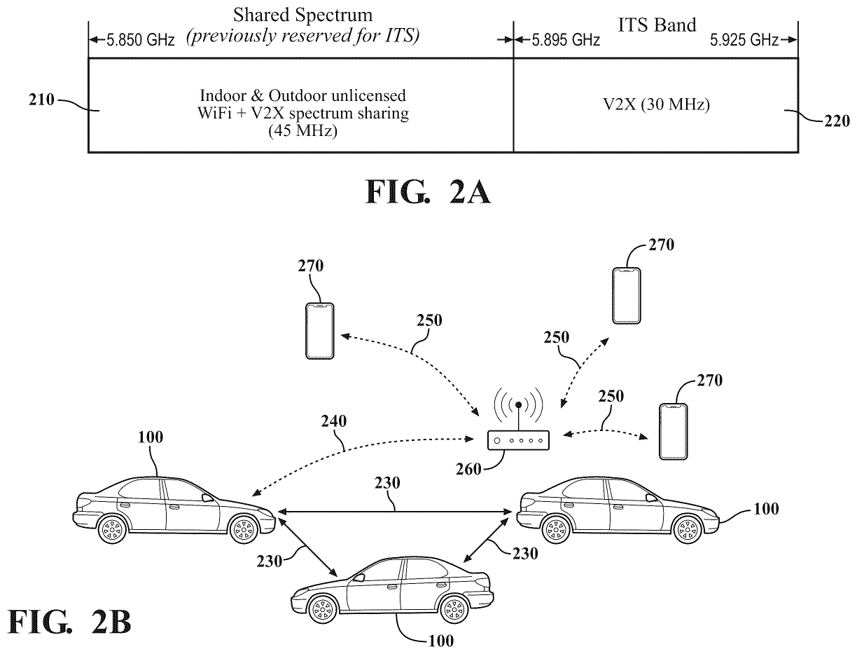

As indicated in FIG. 1, the vehicle 100 includes additional elements. It will be understood that, in various embodiments, it may not be necessary for the vehicle 100 to have all the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1, including spectrum sharing system 175. While the various elements are shown as being located within the vehicle 100 in FIG. 1, it will be understood that one or more of these elements can be located external to the vehicle 100. Further, the elements shown may be physically separated by large distances. Some of the possible elements of the vehicle 100 are shown in FIG. 1. However, a description of many of the elements in FIG. 1 will be provided after the discussion of FIGS. 2-11 for purposes of brevity of this description.

The sensor system 120 of vehicle 100 can include, among other things, one or more vehicle sensors 121. The vehicle sensors 121 can detect, determine, and/or sense information about the vehicle 100 itself, including the operational status of various vehicle components and systems. For example, the vehicle sensors 121 can detect whether the vehicle 100 is parked (stationary) or moving. This vehicle status information can be conveyed to the spectrum sharing system 175 via a controller area network (CAN) of the vehicle 100.

As indicated in FIG. 1, vehicle 100 can communicate with other network nodes 180 (e.g., external Wi-Fi stations, other connected vehicles, cloud servers, edge servers, roadside units, infrastructure devices, etc.) via a network 190. In some embodiments, network 190 includes the Internet. In communicating with the other network nodes 180, vehicle 100 can employ wireless communication technologies such as IEEE 802.11 (Wi-Fi), C-V2X (e.g., 4G LTE-V2X or 5G NR V2X), cellular data, Bluetooth®, Bluetooth® Low Energy (LE), and Dedicated Short-Range Communications (DSRC). In this description, the focus is on Wi-Fi and C-V2X.

FIGS. 2A and 2B illustrate a spectrum sharing arrangement for Wi-Fi and C-V2X communication, in accordance with an illustrative embodiment of the invention. Referring first to FIG. 2A, as discussed above, 30 MHz of spectrum (ITS band 220) is dedicated to ITS, and 45 MHz of spectrum that was previously reserved for ITS is now allocated for the usage of unlicensed devices, such as Wi-Fi 6. The embodiment in FIGS. 2A and 2B enables that 45 MHz to be used by a vehicle 100 as shared spectrum 210 for Wi-Fi and C-V2X communication. It is important to note that, in other embodiments, the techniques discussed herein can be extended to make use, as shared spectrum, of other portions of the spectrum such as the Unlicensed National Information Infrastructure band 3 (UNII-3 band) from 5.725 to 5.850 GHz used by Wi-Fi and Industrial, Scientific, and Medical (ISM) devices. Thus, the embodiment in FIGS. 2A and 2B is illustrative, not limiting, regarding the portion or portions of the spectrum to which the spectrum-sharing techniques described herein can be applied.

FIG. 2B illustrates ways in which the shared spectrum 210 can be used. As shown in FIG. 2B, connected vehicles 100 can communicate with one another on the unlicensed 45-MHz band (shared spectrum 210) via C-V2X communication links 230. Similarly, vehicle Wi-Fi traffic 240 (Wi-Fi traffic from a vehicle 100) and external-station Wi-Fi traffic 250 from external stations 270 can also be carried on the unlicensed band (shared spectrum 210) via an external Wi-Fi access point 260. In this context, the term “external” refers to the Wi-Fi stations 270 in question being external to a vehicle 100.

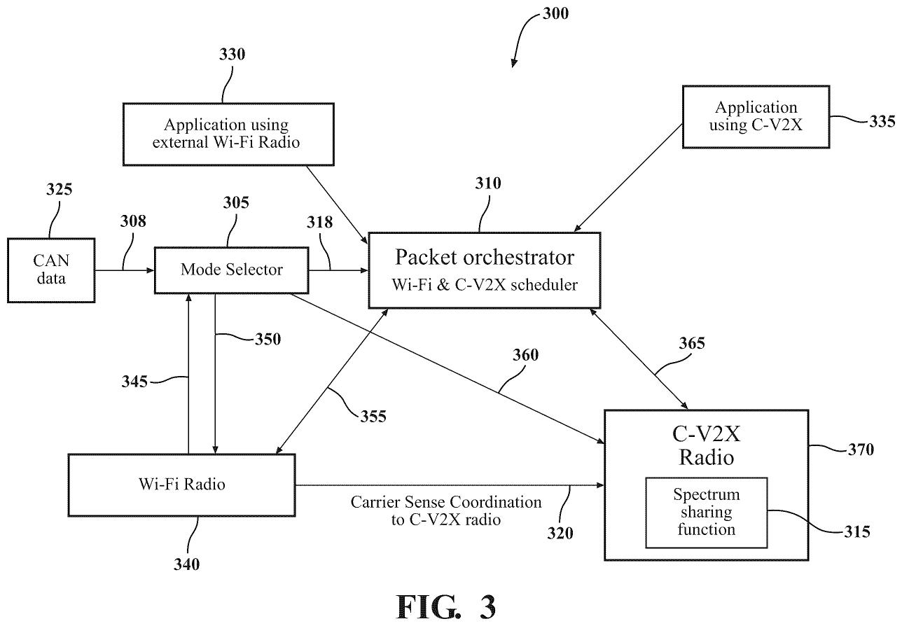

FIG. 3 is a diagram of an architecture 300 of a spectrum sharing system 175, in accordance with an illustrative embodiment of the invention. The overall architecture 300 shown in FIG. 3 is modified somewhat in some of the subsequent figures to reflect the specific configurations of three different modes of operation of spectrum sharing system 175. Those three different modes of operation are discussed in detail below.

As shown in FIG. 3, a vehicle 100 includes a Wi-Fi radio 340 and a C-V2X radio 370. In some embodiments, the Wi-Fi radio 340 is external-facing (i.e., used to communicate with external Wi-Fi stations 270). For example, when a vehicle 100 is parked at the owner's home or office and the Wi-Fi radio 340 is connected with the owner's home or office Wi-Fi network, the vehicle 100 can receive a firmware update via a shared channel within the shared spectrum 210 discussed above. The firmware update is an example of an external Wi-Fi application 330 with which the vehicle 100 can communicate. In other embodiments, the Wi-Fi radio 340 is internal (i.e., supports a Wi-Fi hotspot within the vehicle 100). In those embodiments, the spectrum-sharing principles described herein can be applied to sharing the unlicensed band (210) between Wi-Fi communication within a vehicle 100 and C-V2X communication with network nodes 180 external to the vehicle 100.

From the CAN data 325, the system 175 obtains vehicle status information 308 indicating whether the vehicle 100 is parked (stationary) or moving. In the various embodiments described herein, the mode selector 305 selects the mode of operation of spectrum sharing system 175 for the use of the unlicensed spectrum (shared spectrum 210) based on (1) vehicle status information 308 (parked vs. moving) and (2) Wi-Fi activity information 345 (information regarding the absence or presence of Wi-Fi activity on the shared channel) from the Wi-Fi radio 340. Mode selector 305 accomplishes this through mode selection signal 318 to packet orchestrator 310, Wi-Fi control information 350 to Wi-Fi radio 340, and C-V2X control information 360 to C-V2X radio 370. Based on the selected mode indicated by the mode selection signal 318 output by mode selector 305, packet orchestrator 310 orchestrates the flow of Wi-Fi packets 355 and C-V2X packets 365 to use the shared spectrum 210 in connection with the Wi-Fi application 330 and/or the C-V2X application 335 of the vehicle 100. As discussed further below, when the vehicle 100 is moving, the C-V2X radio 370 operates consistently with the selected mode and carrier sense coordination 320 from Wi-Fi radio 340 to use the shared spectrum 210 exclusively, in the absence of external Wi-Fi stations 270, or to use a spectrum sharing function 315 (described in greater detail below), when traffic (250) from external Wi-Fi stations 270 is detected.

In the various embodiments of a spectrum sharing system 175, there are two high-level modes of operation, herein referred to as “Mode A” and “Mode B,” depending on the vehicle's communication needs and the communication context external to the vehicle 100. In some embodiments, Mode B, in turn, breaks out into two sub-modes, Mode B1 and Mode B2, depending on whether the vehicle's external-facing Wi-Fi radio 340 detects transmissions from external Wi-Fi stations 270 on the channel shared by Wi-Fi and C-V2X. These three modes of operation can be summarized as follows:
Mode A: Vehicle 100 is parked, and only Wi-Fi and not C-V2X communication is generated by the vehicle 100 on the shared channel.
Mode B: Vehicle 100 is moving, and only C-V2X and not Wi-Fi communication is generated by the vehicle 100 on the shared channel. This mode is divided into two sub-modes:
   Mode B1: There is an absence of Wi-Fi communication (250) from external stations (270) on the shared channel.
   Mode B2: There is Wi-Fi communication (250) present from external stations (270) on the shared channel.

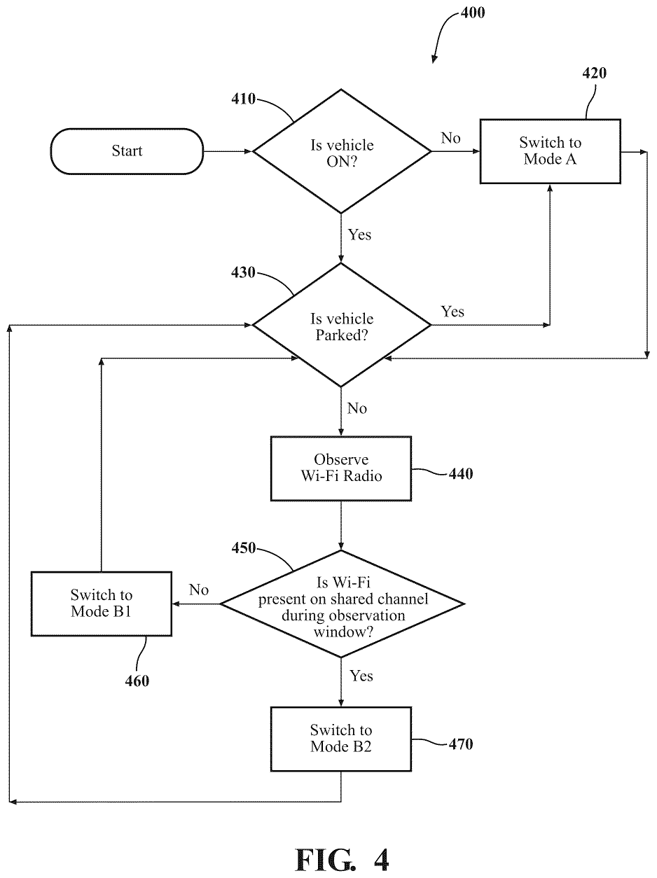

Note that it is when the spectrum sharing system 175 is in Mode B2 that true sharing of the shared spectrum 210 (coordination of Wi-Fi and C-V2X transmissions) takes place. That is, coordination of Wi-Fi and C-V2X transmissions comes into play. The mode switching carried out by the system 175 is summarized in FIG. 4.

FIG. 4 is a flowchart of a mode switching process 400 of a spectrum sharing system 175, in accordance with an illustrative embodiment of the invention. If the vehicle 100 is not running (is turned off) at block 410, mode selector 305 selects Mode A at block 420. If the vehicle is running (is turned on) at block 410, the system 175 checks, at block 430, whether vehicle 100 is parked based on vehicle status information 308. If so, mode selector 305 selects Mode A at block 420. Note that when vehicle 100 is parked and switched off, C-V2X applications/services are inactive. When vehicle 100 is parked but switched on, use of the dedicated C-V2X channels (ITS band 220) may suffice for C-V2X applications, so the C-V2X radio 370 does not need to use a shared channel in shared spectrum 210, consistent with Mode A. If vehicle 100 is moving at block 430 based on vehicle status information 308, Wi-Fi radio 340, at block 440, monitors the shared channel for Wi-Fi activity (250) to generate Wi-Fi activity information 345. If the Wi-Fi activity information 345 indicates, at block 450, that no Wi-Fi traffic (250) is present on the shared channel during the observation window, mode selector 305 selects Mode B1 at block 460. Otherwise, if Wi-Fi traffic (250) is present at block 450, mode selector 305 selects Mode B2 at block 470. As explained above, mode selector 305 uses mode selection signal 318, Wi-Fi control information 350, and C-V2X control information 360 to switch the system 175 dynamically among the three different modes of operation (Modes A, B1, and B2) as conditions (the status of vehicle 100 and the state of Wi-Fi traffic on the shared channel) change.

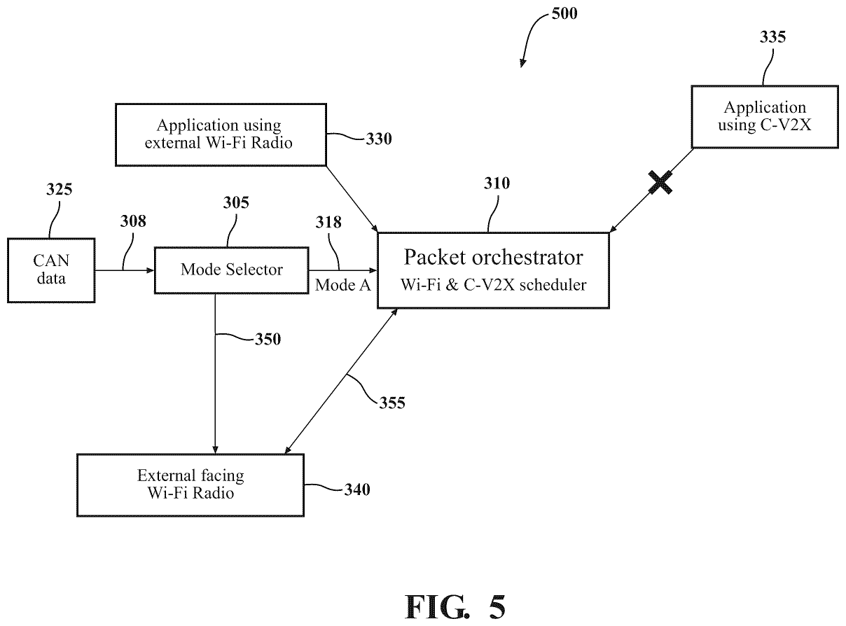

FIG. 5 illustrates a configuration 500 of a first mode (Mode A) of a spectrum sharing system 175, in accordance with an illustrative embodiment of the invention. As explained above, the Mode A configuration 500 in FIG. 5 is a modified version of the overall architecture 300 in FIG. 300 that reflects how system 175 operates in Mode A. Recall that mode selector 305 selects Mode A when vehicle 100 is parked, based on vehicle status information 308. Note that, in Mode A, mode selector 305 and packet orchestrator 310 are both active, but C-V2X application 335, C-V2X radio 370, spectrum sharing function 315, and carrier sense coordination 320 (refer to FIG. 3) are not in play because there is no usage of the shared channel by C-V2X radio 370.

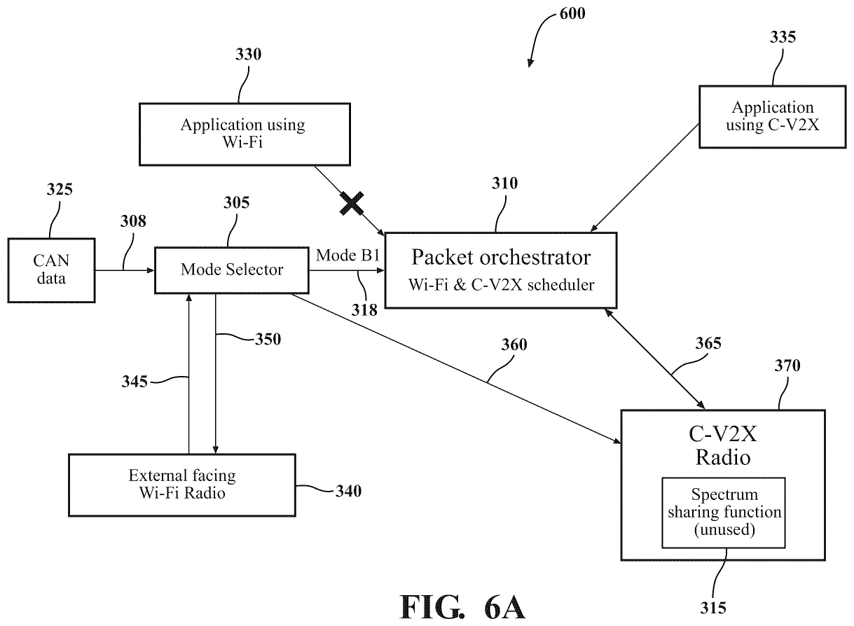

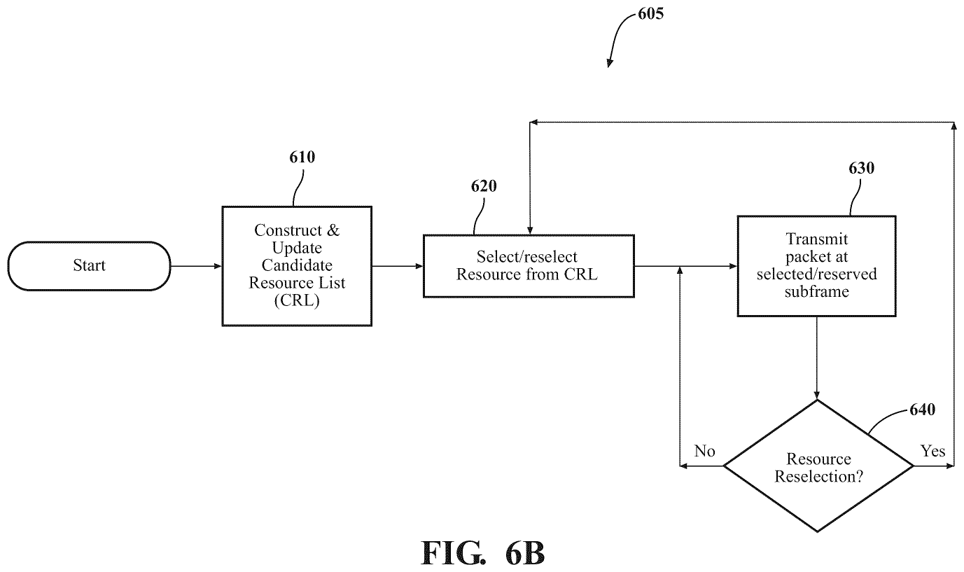

FIG. 6A illustrates a configuration 600 of a second mode (Mode B1) of a spectrum sharing system 175, in accordance with an illustrative embodiment of the invention. As mentioned above, the Mode-B1 configuration 600 in FIG. 6A is a modified version of the overall architecture 300 in FIG. 300 that reflects how system 175 operates in Mode B1. As discussed above in connection with FIG. 4, mode selector 305 selects Mode B1 when the vehicle 100 is moving, based on vehicle status information 308, and no external Wi-Fi traffic (250) is detected on the shared channel. In Mode B1, there are only C-V2X packets 365 from the vehicle 100 on the shared channel (in shared spectrum 210). In this mode, packet orchestrator 310 permits no Wi-Fi applications 330 to use the external-facing Wi-Fi radio 340 because the moving vehicle 100 is not connected to a fixed and authenticated Wi-Fi access point 260. Moreover, as just mentioned, in Mode B1, there is no external Wi-Fi traffic (250) detected by the vehicle's Wi-Fi radio 340 on the shared channel. Consequently, the vehicle 100 may use the shared channel in the shared spectrum 210 for C-V2X communication (365) using standardized or modified C-V2X protocols such as 3 GPP Rel-14/15 LTE-V2X sidelink, Rel-16/17/18 5G NR-V2X sidelink, or, in other embodiments, any other C-V2X protocol versions without using any additional spectrum sharing functionality. Note that, as indicated in FIG. 6A, spectrum sharing function 315 is unused in Mode B1, as is the carrier sense coordination 320 function (not shown in FIG. 6A).

FIG. 6B is a flowchart of a Mode-B1 channel usage process 605, in accordance with an illustrative embodiment of the invention. Channel usage process 605 is one example based on use of the standardized semi-persistent scheduling (SPS) resource (re-)selection procedure in 3GPP Rel-14/15 LTE-V2X sidelink or Rel-16/17 NR-V2X sidelink. In other embodiments, one-shot transmissions instead of SPS transmissions and/or interleaving of SPS transmissions and one-shot transmissions are used. In channel usage process 605, packet orchestrator 310 constructs and updates a Candidate Resource List (CRL) at block 610. At block 620, packet orchestrator 310 selects or reselects a resource from the CRL. At block 630, packet orchestrator 310 transmits the C-V2X packets 365 at the selected/reserved subframe. If resource re-selection is needed at block 640, control returns to block 620. Otherwise, control returns to block 630.

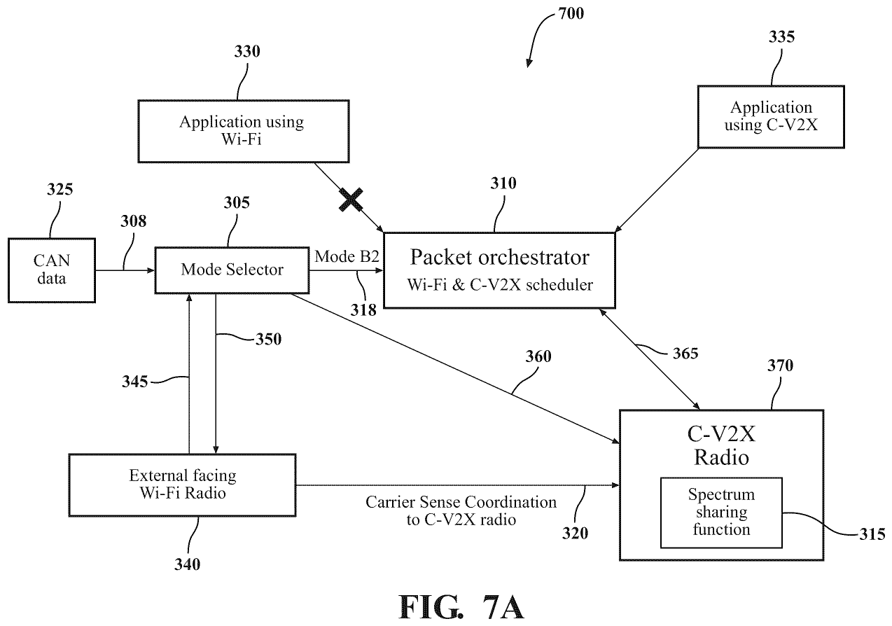

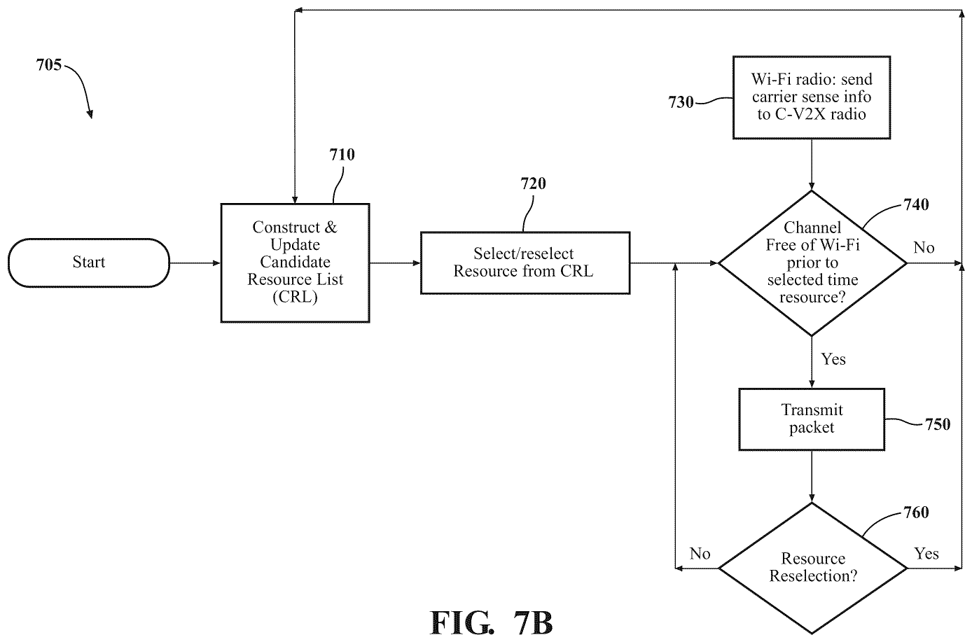

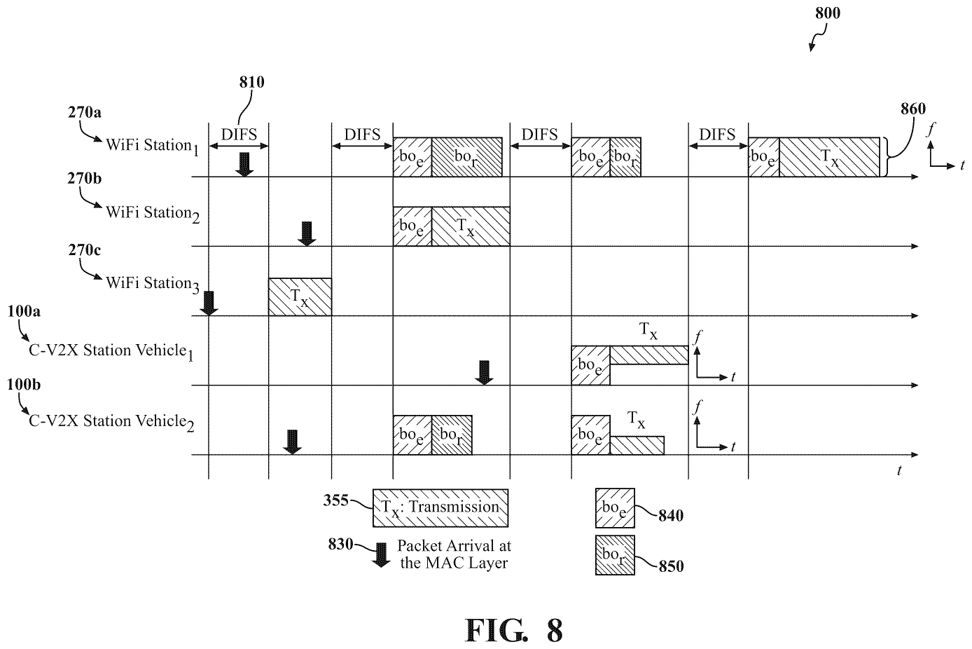

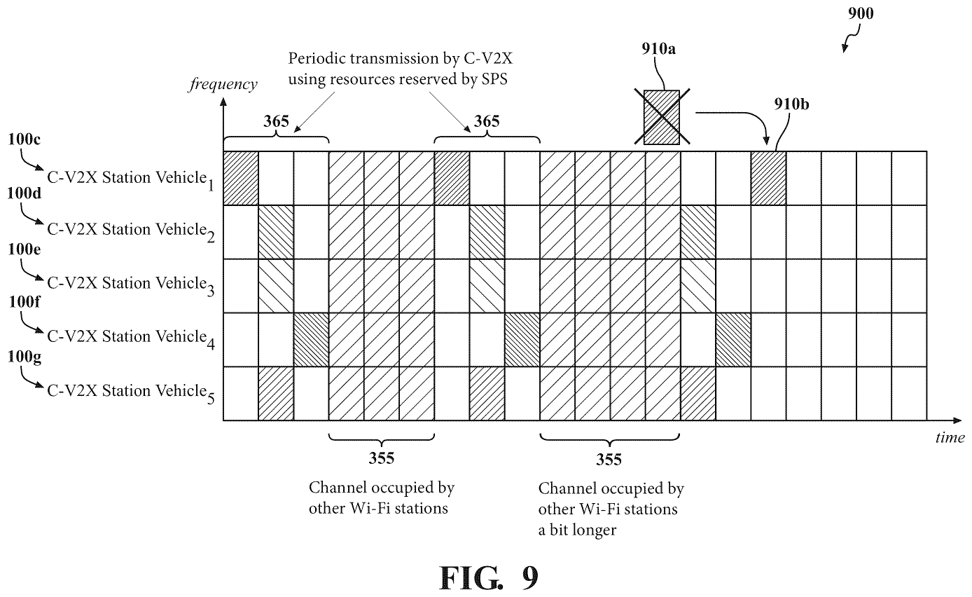

FIG. 7A illustrates a configuration 700 of a third mode (Mode B2) of a spectrum sharing system 175, in accordance with an illustrative embodiment of the invention. As mentioned above, the Mode-B2 configuration 700 in FIG. 7A is a modified version of the overall architecture 300 in FIG. 300 that reflects how system 175 operates in Mode B2. As with Mode B1 discussed above, mode selector 305 selects Mode B2 when the vehicle 100 is moving, based on vehicle status information 308. As in Mode B1, in Mode B2 there are only C-V2X packets 365 from the vehicle 100 on the shared channel (in shared spectrum 210), and no Wi-Fi applications 330 are allowed to use the external-facing Wi-Fi radio 340. However, unlike Mode B1, in Mode B2, external Wi-Fi traffic (250) is detected by the vehicle's Wi-Fi radio 340 on the shared channel from external Wi-Fi devices 270. This Wi-Fi carrier sense information from carrier sense coordination 320 is communicated to the vehicle's C-V2X radio 370, which uses the shared channel subject to additional spectrum-sharing functionality (spectrum sharing function 315 in FIG. 7A) to avoid concurrent Wi-Fi and C-V2X transmission that interferes with the external Wi-Fi communication (250). This is described in further detail below in connection with FIGS. 8 and 9.

FIG. 7B is a flowchart of a Mode-B2 channel usage process 705, in accordance with an illustrative embodiment of the invention. Channel usage process 705 is one example of C-V2X in coordination with Wi-Fi in Mode B2 using 3 GPP Rel-14/15 LTE-V2X sidelink or Rel-16/17 NR-V2X sidelink and additional spectrum sharing functionality (315) to avoid interference with external Wi-Fi communication (250). One-shot transmissions instead of SPS transmissions and/or interleaving of SPS transmissions and one-shot transmissions are deployed in other embodiments. As shown in FIG. 7B, C-V2X radio 370 constructs and updates a CRL at block 710. At block 720, packet C-V2X radio 370 selects or reselects a resource from the CRL. At block 730, Wi-Fi radio 340 of vehicle 100 sends carrier sense information from carrier sense coordination 320 to C-V2X radio 370. If the shared channel is free of Wi-Fi traffic (250) prior to the selected time resource at block 740, the current C-V2X packet 365 is transmitted at block 750. If, at block 740, the shared channel is not free of Wi-Fi traffic (250), control returns to block 710. If resource selection is needed at block 760, control again returns to block 710. Otherwise, control returns to block 740.

FIG. 8 illustrates a macroscopic example 800 of Mode B2, in accordance with an illustrative embodiment of the invention. The example in FIG. 8 illustrates how, when the system 175 is operating in Mode B2, Wi-Fi and C-V2X stations can share the channel (in shared spectrum 210) without interference. For clarity, some elements in FIG. 8 are identified with reference numerals only in the legend at the bottom of the figure. FIG. 8 shows temporal shared-channel usage by three external Wi-Fi stations (270a-c) and two C-V2X stations (vehicles 100a and 100b). The external Wi-Fi stations 270 access the channel using a standardized IEEE 802.11 CSMA/CA procedure, which involves Distributed Coordination Function (DCF) Interframe Space (DIFS 810) and random backoff window (see examples of the elapsed backoff times 840 and remaining backoff times 850 in FIG. 8). This minimizes concurrent transmission among stations contending for shared-channel access in the time domain. In this example C-V2X Station 1 (vehicle 100a) and C-V2X Station 2 (vehicle 100b) access the shared channel when it is sensed as free by the vehicle's Wi-Fi radio 340. The time-dimension access to the shared channel by the C-V2X traffic (365) of vehicles 100a and 100b is coordinated (via contention) with external Wi-Fi traffic (250) in the shared channel using CSMA/CA to avoid collisions between C-V2X and Wi-Fi transmissions.

Though transmission of both vehicles'C-V2X packets 365 may overlap in the time domain, using different sub-channels in the frequency domain prevents collisions between C-V2X packets 365 from the two vehicles 100a and 100b. In other words, the C-V2X stations (vehicles 100 a and 100 b) self-organize between themselves by, e.g., using the existing standardized 3GPP LTE-V2X resource (re-)selection procedure for SPS, one-shot transmission, or other mechanisms to stagger time and frequency resources to avoid collisions between C-V2X transmissions from the vehicles 100a and 100b. As shown in FIG. 8, the downward-pointing arrows (830) indicate the times at which packets arrive at the MAC layer. Referring to annotation 860, note that external Wi-Fi station 270a, in example 800, uses the entire spectrum in the frequency domain.

To elaborate somewhat further regarding the avoidance of collisions among external Wi-Fi stations 270, if a Wi-Fi station (270a, 270b, or 270c) detects that the shared channel is busy, that station waits until the medium is idle for an Inter-Frame Space (IFS), then it additionally waits for a random backoff time within the contention window for collision avoidance. As those skilled in the art are aware, a countdown backoff timer is decremented for as long as the medium is sensed as idle, but it is frozen (halted) when a transmission on the channel is detected. Frozen nodes (stations) do not choose a new random backoff time. Instead, they continue to count down the remaining backoff time. This accounts for the elapsed backoff times 840 and remaining backoff times 850 shown in FIG. 8. When the countdown backoff timer reaches zero, the station 270 transmits its own frame. Wi-Fi stations 270 having different random backoff times helps to avoid interference caused by multiple stations transmitting concurrently.

FIG. 9 illustrates a Mode-B2 channel resource usage example 900, in accordance with an illustrative embodiment of the invention. Example 900 illustrates channel resource usage by five C-V2X stations (vehicles 100c-g). In FIG. 9, the vertical axis represents the frequency domain, and the horizontal axis represents the time domain. In this example, the C-V2X stations 100c-g reserve and use channel resources recurrently, e.g., using the 3 GPP Rel-14/15 LTE-V2X SPS mechanism. In other embodiments, the vehicles 100 c-g may use other releases of 3GPP C-V2X technology, such as Release 16 or beyond. Although the vehicles 100c-g reserve resources using SPS, the final decision of whether to use the reserved resource is subject to the detected presence of external Wi-Fi communication (250) on the shared channel. During the third cycle of example 900, vehicle 100c originally had a resource (910a) reserved at a particular time resource, but the shared channel was occupied by Wi-Fi external communication (250, 355) during that time, which caused vehicle 100c to discard its previous reservation (i.e., packet dropping) and wait for the subsequent SPS resource (910b) at a future time to avoid interference with ongoing Wi-Fi communication (250, 355) on the shared channel.

Note, however, that the system 175 does not know in advance for how long the Wi-Fi activity (250) will continue. Instead, the system 175 senses the Wi-Fi activity (250) on the shared channel in real time and cancels/discards resource-block reservations as needed so the C-V2X radio 370 can transmit without interfering with Wi-Fi transmissions (250) on the shared channel. For C-V2X, the reservation of future resource blocks is based, in part, on a knowledge of past channel activity. In contrast, Wi-Fi is opportunistic and probabilistic in its approach in real time. A key aspect of the various embodiments described herein is coordinating C-V2X transmissions (365) on the shared channel in accordance with detected Wi-Fi activity (250) on the shared channel, the Wi-Fi activity (250) being detected by the vehicle's co-located Wi-Fi radio 340 (in some embodiments external-facing; in other embodiments, internal, as discussed above).

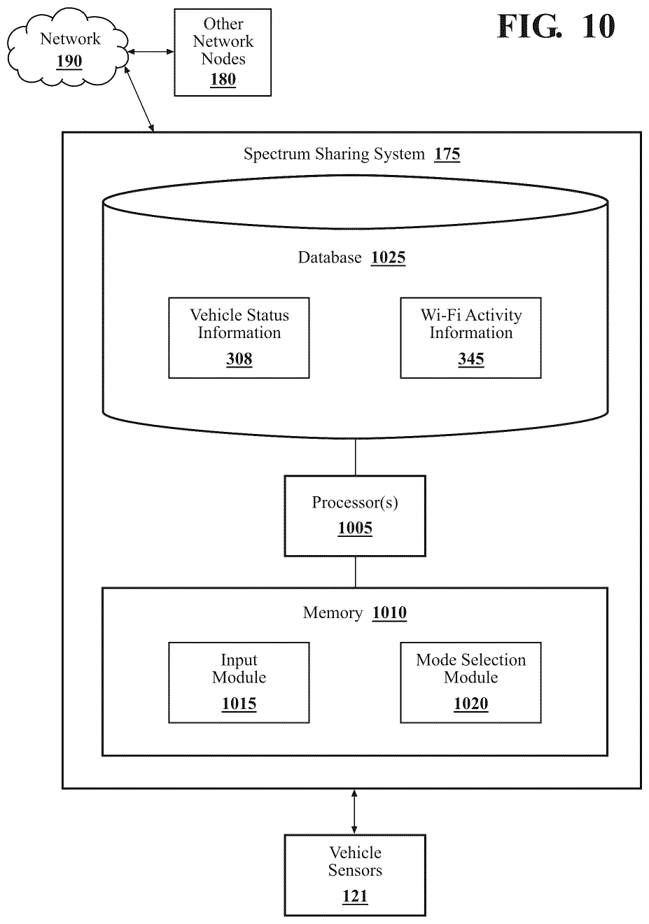

FIG. 10 is a block diagram of a spectrum sharing system 175, in accordance with an illustrative embodiment of the invention. In FIG. 10, the system 175 includes one or more processors 1005 to which a memory 1010 is communicably coupled. The one or more processors 1005 may be dedicated to the system 175, the system 175 may share one or more of the processors 110 of vehicle 100, or the system 175 may access the one or more processors 110 of vehicle 100 through a data bus or another communication path, depending on the embodiment. Memory 1010 stores an input module 1015 and a mode selection module 1020. The input module 1015 and the mode selection module 1020 together implement, among other things, the functionality of mode selector 305, packet orchestrator 310, carrier sense coordination 320, and spectrum sharing function 315 discussed above in connection with FIG. 3. The memory 1010 is a random-access memory (RAM), read-only memory (ROM), a hard-disk drive, a flash memory, or other suitable non-transitory memory for storing the modules 215 and 220. The modules 215 and 220 are, for example, machine-readable instructions that, when executed by the one or more processors 1005, cause the one or more processors 1005 to perform the various functions disclosed herein.

As shown in FIG. 10, the system 175 interfaces with the various vehicle sensors 121 of vehicle 100, as discussed above. As also discussed above, vehicle status information 308, which indicates whether the vehicle 100 is parked or moving, is derived from vehicle sensors 121 and can be conveyed to the system 175 via the vehicle's CAN (see CAN data 325 in FIG. 3).

As also shown in FIG. 10, spectrum sharing system 175 can store various kinds of data in a database 1025. For example, system 175 can store, in the database 1025, vehicle status information 308 and Wi-Fi activity information 345 output by the Wi-Fi radio 340.

As discussed above in connection with FIG. 1, the system 175 communicates with other network nodes 180 (e.g., external Wi-Fi stations, other connected vehicles, cloud servers, edge servers, roadside units, infrastructure devices, etc.) via a network 190. In some embodiments, network 190 includes the Internet. In communicating with the other network nodes 180, system 175 can employ wireless communication technologies such as IEEE 802.11 (Wi-Fi), C-V2X (e.g., 4G LTE-V2X or 5G NR V2X), cellular data, Bluetooth®, Bluetooth® Low Energy (LE), and Dedicated Short-Range Communications (DSRC). As discussed above, the particular focus, in this description, is on Wi-Fi and C-V2X communications.

Input module 1015 generally includes machine-readable instructions that, when executed by the one or more processors 1005, cause the one or more processors 1005 to receive vehicle status information 308 indicating whether a vehicle 100 is parked or moving. Input module 1015 also includes machine-readable instructions that, when executed by the one or more processors 1005, cause the one or more processors 1005 to receive, from a Wi-Fi radio 340 of the vehicle, information regarding Wi-Fi activity 345 on a shared channel designated for both Wi-Fi and C-V2X communication. As discussed above, vehicle status information 308 is derived from vehicle sensors 121 and can be conveyed to input module 1015 via the vehicle's CAN.

Mode selection module 1020 generally includes machine-readable instructions that, when executed by the one or more processors 1005, cause the one or more processors 1005 to select, based on the vehicle status information 308 and the information regarding Wi-Fi activity 345, a mode of operation of the C-V2X radio 370 of the vehicle 100 and the Wi-Fi radio 340 of the vehicle 100 that avoids interference between Wi-Fi and C-V2X on the shared channel (in shared spectrum 210). As mentioned above, mode selection module 1020 implements, among other things, the functionality of mode selector 305 discussed above in connection with FIG. 3. The logic on which mode selector 305 bases selection of the mode of operation (Mode A, Mode B1, or Mode B2) is discussed above in connection with FIG. 4. As discussed above, mode selector 305 outputs a mode selection signal 318 that governs, in part, the operation of packet orchestrator 310; Wi-Fi control information 350 that governs, in part, the operation of Wi-Fi radio 340; and C-V2X control information 360 that governs, in part, the operation of C-V2X radio 370, particularly the spectrum sharing function 315 of the C-V2X radio 370.

As discussed above, in some embodiments, the Wi-Fi radio 340 is external-facing (i.e., used to communicate with external Wi-Fi stations 270). In other embodiments, the Wi-Fi radio 340 is internal (i.e., supports a Wi-Fi hotspot within the vehicle 100). In those embodiments, the spectrum-sharing principles described herein are applied to sharing the unlicensed band (210) between Wi-Fi communication within a vehicle 100 and external C-V2X communication.

The modes of operation that mode selection module 1020 selects in implementing the functionality of mode selector 305 (see discussion of FIG. 3 above) will next be summarized.

Mode A: When the vehicle status information 308 indicates that the vehicle 100 is parked, the machine-readable instructions in mode selection module 1020, when executed by the one or more processors 1005, cause the one or more processors 1005 to select the mode of operation of system 175 to be one in which, of the Wi-Fi radio 340 and the C-V2X radio 370, only the Wi-Fi radio 340 communicates over the shared channel. Mode A is described in greater detail above in connection with FIG. 5.

Mode B1: When the vehicle status information 308 indicates that the vehicle 100 is moving and the information regarding Wi-Fi activity 345 on the shared channel indicates an absence of Wi-Fi communication (250) from stations (270) external to the vehicle 100, the machine-readable instructions in mode selection module 1020, when executed by the one or more processors 1005, cause the one or more processors 1005 to select the mode of operation to be one in which, of the Wi-Fi radio 340 and the C-V2X radio 370, only the C-V2X radio 370 communicates over the shared channel. Mode B1 is described in greater detail above in connection with FIGS. 6A and 6B.

Mode B2: When the vehicle status information 308 indicates that the vehicle 100 is moving and the information regarding Wi-Fi activity 345 on the shared channel indicates the presence of Wi-Fi communication (250) from one or more stations (270) external to the vehicle 100, the machine-readable instructions in mode selection module 1020, when executed by the one or more processors 1005, cause the one or more processors 1005 to select the mode of operation to be one in which, of the Wi-Fi radio 340 and the C-V2X radio 370, only the C-V2X radio 370 communicates over the shared channel during one or more periods in which the shared channel is free of Wi-Fi transmissions (250, 355) from the one or more stations (270) external to the vehicle 100. It is in this mode of operation that the shared channel is truly shared (coordinated in time) between Wi-Fi and C-V2X communications. Mode B2 is described in greater detail above in connection with FIGS. 7A, 7B, 8, and 9.

One aspect of Mode B2 discussed above in connection with example 900 in FIG. 9 is the following: In some embodiments, the machine-readable instructions in mode selection module 1020 include further instructions that, when executed by the one or more processors 1005, cause the one or more processors 1005 to discard an existing C-V2X resource reservation (910a) and create a new C-V2X resource reservation (910b) for a later time in response to detecting that the shared channel is occupied by a transmission (250) from the one or more stations (270) external to the vehicle 100.

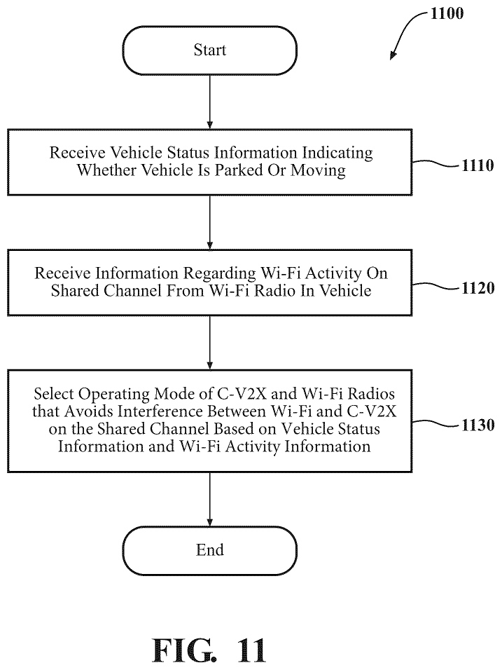

FIG. 11 is a flowchart of a method 1100 of Wi-Fi and C-V2X spectrum sharing, in accordance with an illustrative embodiment of the invention. Method 1100 will be discussed from the perspective of the spectrum sharing system 175 in FIG. 10. While method 1100 is discussed in combination with spectrum sharing system 175, it should be appreciated that method 1100 is not limited to being implemented within the system 175, but the system 175 is instead one example of a system that may implement method 1100.

At block 1110, input module 1015 receives vehicle status information 308 indicating whether a vehicle 100 is parked or moving. As discussed above, vehicle status information 308 is derived from vehicle sensors 121 (e.g., a vehicle-speed sensor) and can be conveyed to input module 1015 via the vehicle's CAN (refer to CAN data 325 in FIG. 3).

At block 1120, input module 1015 receives, from a Wi-Fi radio 340 of the vehicle 100, information regarding Wi-Fi activity 345 on a shared channel designated for both Wi-Fi and C-V2X communication.

At block 1130, mode selection module 1020 selects, based on the vehicle status information 308 and the information regarding Wi-Fi activity 345, a mode of operation of a C-V2X radio 370 of the vehicle and the Wi-Fi radio 340 of the vehicle 100 that avoids interference between Wi-Fi and C-V2X on the shared channel. As discussed above, mode selection module 1020 implements, among other things, the functionality of mode selector 305 discussed above in connection with FIG. 3. The logic on which mode selector 305 bases selection of the mode of operation (Mode A, Mode B1, or Mode B2) is discussed above in connection with FIG. 4. As discussed above, mode selector 305 outputs a mode selection signal 318 that governs, in part, the operation of packet orchestrator 310; Wi-Fi control information 350 that governs, in part, the operation of Wi-Fi radio 340; and C-V2X control information 360 that governs, in part, the operation of C-V2X radio 370, particularly the spectrum sharing function 315 of the C-V2X radio 370.

As discussed above, in some embodiments, the Wi-Fi radio 340 is external-facing (i.e., used to communicate with external Wi-Fi stations 270). In other embodiments, the Wi-Fi radio 340 is internal (i.e., supports a Wi-Fi hotspot within the vehicle 100). In those embodiments, the spectrum-sharing principles described herein can be applied to sharing the unlicensed band (210) between Wi-Fi communication within a vehicle 100 and external C-V2X communication.

The modes of operation that mode selection module 1020 selects in implementing the functionality of mode selector 305 (see discussion of FIG. 3 above) will next be summarized once again in connection with method 1100.

Mode A: When the vehicle status information 308 indicates that the vehicle 100 is parked, mode selection module 1020 selects the mode of operation of system 175 to be one in which, of the Wi-Fi radio 340 and the C-V2X radio 370, only the Wi-Fi radio 340 communicates over the shared channel. Mode A is described in greater detail above in connection with FIG. 5.

Mode B1: When the vehicle status information 308 indicates that the vehicle 100 is moving and the information regarding Wi-Fi activity 345 on the shared channel indicates an absence of Wi-Fi communication (250) from stations (270) external to the vehicle 100, mode selection module 1020 selects the mode of operation to be one in which, of the Wi-Fi radio 340 and the C-V2X radio 370, only the C-V2X radio 370 communicates over the shared channel. Mode B1 is described in greater detail above in connection with FIGS. 6A and 6B.

Mode B2: When the vehicle status information 308 indicates that the vehicle 100 is moving and the information regarding Wi-Fi activity 345 on the shared channel indicates the presence of Wi-Fi communication (250) from one or more stations (270) external to the vehicle 100, mode selection module 1020 selects the mode of operation to be one in which, of the Wi-Fi radio 340 and the C-V2X radio 370, only the C-V2X radio 370 communicates over the shared channel during one or more periods in which the shared channel is free of Wi-Fi transmissions (250, 355) from the one or more stations (270) external to the vehicle 100. It is in this mode of operation that the shared channel in the shared spectrum 210 is truly shared (coordinated in time) between Wi-Fi and C-V2X communications. Mode B2 is described in greater detail above in connection with FIGS. 7A, 7B, 8, and 9.

One aspect of Mode B2 discussed above in connection with the example of FIG. 9 is the following: In some embodiments, mode selection module 1020, in implementing the functionality of packet orchestrator 310 and spectrum sharing function 315, discards an existing C-V2X resource reservation (910a) and creates a new C-V2X resource reservation (910b) for a later time in response to detecting that the shared channel is occupied by a transmission (250) from the one or more stations (270) external to the vehicle 100.

In some embodiments, the communications to and from a vehicle 100 via C-V2X support controlling, at least in part, the operation of the vehicle 100. This can involve controlling one or more of steering, acceleration, and braking (e.g., automated or semi-automated driving) based on information received at the vehicle 100 from a traffic-control or traffic-information server or from other connected vehicles. Such communications between the vehicle 100 and a traffic-information server, a traffic-control server, or other connected vehicles also support, without limitation, techniques such as speed advisories, re-routing requests or directives, platooning of a group of connected vehicles, and coordinated traversal with other connected vehicles of traffic-signal-controlled intersections.

FIG. 1 will now be discussed in full detail as an example vehicle environment within which the systems and methods disclosed herein may be implemented. In some instances, the vehicle 100 can be configured to switch selectively between an automated mode, one or more semi-automated operational modes, and/or a manual mode. Such switching, also referred to as handover when transitioning to a manual mode, can be implemented in a suitable manner, now known or later developed. “Manual mode” means that all of or a majority of the navigation and/or maneuvering of the vehicle is performed according to inputs received from a user (e.g., human driver/operator).

In one or more implementations, the vehicle 100 can be an automated vehicle. As used herein, “automated vehicle” refers to a vehicle that operates in an automated mode. “Automated mode” refers to navigating and/or maneuvering a vehicle along a travel route using one or more computing devices to control the vehicle with minimal or no input from a human driver/operator. In one implementation, the vehicle 100 is configured with one or more semi-automated operational modes in which one or more computing devices perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route. Thus, in one or more implementations, the vehicle 100 operates autonomously according to a particular defined level of autonomy.

The vehicle 100 can include one or more processors 110. In one or more arrangements, the one or more processors 110 can be a main processor of the vehicle 100. For instance, the one or more processors 110 can be an electronic control unit (ECU). The vehicle 100 can include one or more data stores 115 for storing one or more types of data. The data store(s) 115 can include volatile and/or non-volatile memory. Examples of suitable data stores 115 include RAM, flash memory, ROM, PROM (Programmable Read-Only Memory), EPROM, EEPROM (Electrically Erasable Programmable Read-Only Memory), registers, magnetic disks, optical disks, hard drives, or any other suitable storage medium, or any combination thereof. The data store(s) 115 can be a component(s) of the one or more processors 110, or the data store(s) 115 can be operatively connected to the one or more processors 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangement, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangement, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can function independently from each other. Alternatively, two or more of the sensors can work in combination with each other. In such a case, the two or more sensors can form a sensor network. The sensor system 120 and/or the one or more sensors can be operatively connected to the one or more processors 110, the data store(s) 115, and/or another element of the vehicle 100 (including any of the elements shown in FIG. 1).

The sensor system 120 can include any suitable type of sensor. Various examples of different types of sensors will be described herein. However, it will be understood that the implementations are not limited to the particular sensors described. The sensor system 120 can include one or more vehicle sensors 121. The vehicle sensors 121 can detect, determine, and/or sense information about the vehicle 100 itself, including the operational status of various vehicle components and systems.

In one or more arrangements, the vehicle sensors 121 can be configured to detect, and/or sense position and/orientation changes of the vehicle 100, such as, for example, based on inertial acceleration. In one or more arrangements, the vehicle sensors 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensors 121 can be configured to detect, and/or sense one or more characteristics of the vehicle 100. In one or more arrangements, the vehicle sensors 121 can include a speedometer to determine a current speed of the vehicle 100.

Alternatively, or in addition, the sensor system 120 can include one or more environment sensors 122 configured to acquire, and/or sense driving environment data. “Driving environment data” includes any data or information about the external environment in which a vehicle is located or one or more portions thereof. For example, the one or more environment sensors 122 can be configured to detect, quantify, and/or sense obstacles in at least a portion of the external environment of the vehicle 100 and/or information/data about such obstacles. The one or more environment sensors 122 can be configured to detect, measure, quantify, and/or sense other things in at least a portion the external environment of the vehicle 100, such as, for example, nearby vehicles, lane markers, signs, traffic lights, traffic signs, lane lines, crosswalks, curbs proximate the vehicle 100, off-road objects, etc.

Various examples of sensors of the sensor system 120 are discussed above. The example sensors may be part of the one or more environment sensors 122 and/or the one or more vehicle sensors 121. Moreover, the sensor system 120 can include operator sensors that function to track or otherwise monitor aspects related to the driver/operator of the vehicle 100. However, it will be understood that the implementations are not limited to the particular sensors described. As an example, in one or more arrangements, the sensor system 120 can include one or more radar sensors 123, one or more LIDAR sensors 124, one or more sonar sensors 125, and/or one or more cameras 126.

The vehicle 100 can further include a communication system 130. The communication system 130 can include one or more components configured to facilitate communication between the vehicle 100 and one or more communication sources. Communication sources, as used herein, refers to people or devices with which the vehicle 100 can communicate with, such as external networks, computing devices, operator or occupants of the vehicle 100, or others. As part of the communication system 130, the vehicle 100 can include an input system 131. An “input system” includes any device, component, system, element or arrangement or groups thereof that enable information/data to be entered into a machine. In one or more examples, the input system 131 can receive an input from a vehicle occupant (e.g., a driver or a passenger). The vehicle 100 can include an output system 132. An “output system” includes any device, component, or arrangement or groups thereof that enable information/data to be presented to the one or more communication sources (e.g., a person, a vehicle passenger, etc.). The communication system 130 can further include specific elements which are part of or can interact with the input system 131 or the output system 132, such as one or more display device(s) 133, and one or more audio device(s) 134 (e.g., speakers and microphones).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or combinations thereof, now known or later developed.

The one or more processors 110 and/or the automated driving module(s) 160 can be operatively connected to communicate with the various vehicle systems 140 and/or individual components thereof. For example, returning to FIG. 1, the one or more processors 110 and/or the automated driving module(s) 160 can be in communication to send and/or receive information from the various vehicle systems 140 to control the movement, speed, maneuvering, heading, direction, etc. of the vehicle 100. The one or more processors 110 and/or the automated driving module(s) 160 may control some or all of these vehicle systems 140 and, thus, may be partially or fully automated.

The vehicle 100 can include one or more modules, at least some of which are described herein. The modules can be implemented as computer-readable program code that, when executed by a processor 110, implement one or more of the various processes described herein. The processor 110 can be a device, such as a CPU, which is capable of receiving and executing one or more threads of instructions for the purpose of performing a task. One or more of the modules can be a component of the one or more processors 110, or one or more of the modules can be executed on and/or distributed among other processing systems to which the one or more processors 110 is operatively connected. The modules can include instructions (e.g., program logic) executable by one or more processors 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

In some implementations, the vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine the position and velocity of the vehicle 100. The automated driving module(s) 160 can determine the location of obstacles, or other environmental features including traffic signs, trees, shrubs, neighboring vehicles, pedestrians, etc.

The automated driving module(s) 160 can be configured to determine travel path(s), current automated driving maneuvers for the vehicle 100, future automated driving maneuvers and/or modifications to current automated driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such automated driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140). The noted functions and methods will become more apparent with a further discussion of the figures.

Detailed implementations are disclosed herein. However, it is to be understood that the disclosed implementations are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various implementations are shown in FIGS. 1-11, but the implementations are not limited to the illustrated structure or application.

The flowcharts and block diagrams in the figures illustrate the architecture, functionality, and operation of possible implementations of systems, methods, and computer program products according to various implementations. In this regard, each block in the flowcharts or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can be executed substantially concurrently, or the blocks can sometimes be executed in the reverse order, depending upon the functionality involved.

The systems, components and/or methods described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or methods also can be embedded in a computer-readable storage, such as a computer program product or other data programs storage device, readable by a machine, tangibly embodying a program of instructions executable by the machine to perform methods and methods described herein. These elements also can be embedded in an application product which comprises all the features enabling the implementation of the methods described herein and, which when loaded in a processing system, is able to carry out these methods.

Furthermore, arrangements described herein can take the form of a computer program product embodied in one or more computer-readable media having computer-readable program code embodied or embedded, such as stored thereon. Any combination of one or more computer-readable media can be utilized. The computer-readable medium can be a computer-readable signal medium or a computer-readable storage medium. The phrase “computer-readable storage medium” means a non-transitory storage medium. A computer-readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a RAM, a ROM, an EPROM or Flash memory, an optical fiber, a portable compact disc read-only memory (CD-ROM), a digital versatile disc (DVD), an optical storage device, a magnetic storage device, or any suitable combination of the foregoing. In the context of this document, a computer-readable storage medium can be any tangible medium that can contain, or store a program for use by, or in connection with, an instruction execution system, apparatus, or device.

Program code embodied on a computer-readable medium can be transmitted using any appropriate medium, including but not limited to wireless, wireline, optical fiber, cable, RF, etc., or any suitable combination of the foregoing. Computer program code for carrying out operations for aspects of the present arrangements can be written in any combination of one or more programming languages, including an object-oriented programming language such as Java™, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a LAN or a WAN, or the connection can be made to an external computer (for example, through the Internet using an Internet Service Provider).

In the description above, certain specific details are outlined in order to provide a thorough understanding of various implementations. However, one skilled in the art will understand that the invention may be practiced without these details. In other instances, well-known structures have not been shown or described in detail to avoid unnecessarily obscuring descriptions of the implementations. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one or more implementations” or “an implementation” means that a particular feature, structure or characteristic described in connection with the implementation is included in at least one or more implementations. Thus, the appearances of the phrases “in one or more implementations” or “in an implementation” in various places throughout this specification are not necessarily all referring to the same implementation. Furthermore, the particular features, structures, or characteristics may be combined in any suitable manner in one or more implementations. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings (such as “Background” and “Summary”) and sub-headings used herein are intended only for general organization of topics within the present disclosure and are not intended to limit the disclosure of the technology or any aspect thereof. The recitation of multiple implementations having stated features is not intended to exclude other implementations having additional features, or other implementations incorporating different combinations of the stated features. As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an implementation can or may comprise certain elements or features does not exclude other implementations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an implementation or particular system is included in at least one or more implementations or aspect. The appearances of the phrase “in one aspect” (or variations thereof) are not necessarily referring to the same aspect or implementation. It should also be understood that the various method steps discussed herein do not have to be carried out in the same order as depicted, and not each method step is required in each aspect or implementation.

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions. The term “module,” as used herein, is not intended, under any circumstances, to invoke interpretation of the appended claims under 35 U.S.C. § 112(f).

The terms “a” and “an,” as used herein, are defined as one as or more than one. The term “plurality,” as used herein, is defined as two or more than two. The term “another,” as used herein, is defined as at least a second or more. The terms “including” and/or “having,” as used herein, are defined as including (i.e., open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC).

The preceding description of the implementations has been provided for purposes of illustration and description. It is not intended to be exhaustive or to limit the disclosure. Individual elements or features of a particular implementation are generally not limited to that particular implementation, but, where applicable, are interchangeable and can be used in a selected implementation, even if not specifically shown or described. The same may also be varied in many ways. Such variations should not be regarded as a departure from the disclosure, and all such modifications are intended to be included within the scope of the disclosure.

While the preceding is directed to implementations of the disclosed devices, systems, and methods, other and further implementations of the disclosed devices, systems, and methods can be devised without departing from the basic scope thereof. The scope thereof is determined by the claims that follow.

What is claimed is:

1. A system, comprising:
a processor; and
a memory storing machine-readable instructions that, when executed by the processor, cause the processor to:
receive vehicle status information indicating whether a vehicle is parked or moving;
receive, from a Wi-Fi radio of the vehicle, information regarding Wi-Fi activity on a shared channel designated for both Wi-Fi and Cellular Vehicle-to-Everything (C-V2X) communication; and
select, based on the vehicle status information and the information regarding Wi-Fi activity, a mode of operation of a C-V2X radio of the vehicle and the Wi-Fi radio of the vehicle that avoids interference between Wi-Fi and C-V2X on the shared channel.

2. The system of claim 1, wherein the Wi-Fi radio and the C-V2X radio are both external-facing with respect to the vehicle.

3. The system of claim 2, wherein:
the vehicle status information indicates that the vehicle is parked; and
the machine-readable instructions, when executed by the processor, cause the processor to select the mode of operation to be one in which, of the Wi-Fi radio and the C-V2X radio, only the Wi-Fi radio communicates over the shared channel.

4. The system of claim 2, wherein:
the vehicle status information indicates that the vehicle is moving;
the information regarding Wi-Fi activity on the shared channel indicates an absence of Wi-Fi communication from stations external to the vehicle; and
the machine-readable instructions, when executed by the processor, cause the processor to select the mode of operation to be one in which, of the Wi-Fi radio and the C-V2X radio, only the C-V2X radio communicates over the shared channel.

5. The system of claim 2, wherein:
the vehicle status information indicates that the vehicle is moving;
the information regarding Wi-Fi activity on the shared channel indicates a presence of Wi-Fi communication from one or more stations external to the vehicle; and
the machine-readable instructions, when executed by the processor, cause the processor to select the mode of operation to be one in which, of the Wi-Fi radio and the C-V2X radio, only the C-V2X radio communicates over the shared channel during one or more periods in which the shared channel is free of Wi-Fi transmissions from the one or more stations external to the vehicle.

6. The system of claim 5, wherein the machine-readable instructions include further instructions that, when executed by the processor, cause the processor to discard an existing C-V2X resource reservation and create a new C-V2X resource reservation for a later time in response to detecting that the shared channel is occupied by a transmission from the one or more stations external to the vehicle.

7. The system of claim 1, wherein the Wi-Fi radio supports an internal hotspot of the vehicle.

8. A non-transitory computer-readable medium storing instructions that, when executed by a processor, cause the processor to:
receive vehicle status information indicating whether a vehicle is parked or moving;
receive, from a Wi-Fi radio of the vehicle, information regarding Wi-Fi activity on a shared channel designated for both Wi-Fi and Cellular Vehicle-to-Everything (C-V2X) communication; and
select, based on the vehicle status information and the information regarding Wi-Fi activity, a mode of operation of a C-V2X radio of the vehicle and the Wi-Fi radio of the vehicle that avoids interference between Wi-Fi and C-V2X on the shared channel.

9. The non-transitory computer-readable medium of claim 8, wherein the Wi-Fi radio and the C-V2X radio are both external-facing with respect to the vehicle.

10. The non-transitory computer-readable medium of claim 9, wherein:
the vehicle status information indicates that the vehicle is parked; and
the instructions, when executed by the processor, cause the processor to select the mode of operation to be one in which, of the Wi-Fi radio and the C-V2X radio, only the Wi-Fi radio communicates over the shared channel.

11. The non-transitory computer-readable medium of claim 9, wherein:
the vehicle status information indicates that the vehicle is moving;
the information regarding Wi-Fi activity on the shared channel indicates an absence of Wi-Fi communication from stations external to the vehicle; and
the instructions, when executed by the processor, cause the processor to select the mode of operation to be one in which, of the Wi-Fi radio and the C-V2X radio, only the C-V2X radio communicates over the shared channel.

12. The non-transitory computer-readable medium of claim 9, wherein:
the vehicle status information indicates that the vehicle is moving;
the information regarding Wi-Fi activity on the shared channel indicates a presence of Wi-Fi communication from one or more stations external to the vehicle; and
the instructions, when executed by the processor, cause the processor to select the mode of operation to be one in which, of the Wi-Fi radio and the C-V2X radio, only the C-V2X radio communicates over the shared channel during one or more periods in which the shared channel is free of Wi-Fi transmissions from the one or more stations external to the vehicle.

13. The non-transitory computer-readable medium of claim 8, wherein the Wi-Fi radio supports an internal hotspot of the vehicle.

14. A method, comprising:
receiving vehicle status information indicating whether a vehicle is parked or moving;
receiving, from a Wi-Fi radio of the vehicle, information regarding Wi-Fi activity on a shared channel designated for both Wi-Fi and Cellular Vehicle-to-Everything (C-V2X) communication; and
selecting, based on the vehicle status information and the information regarding Wi-Fi activity, a mode of operation of a C-V2X radio of the vehicle and the Wi-Fi radio of the vehicle that avoids interference between Wi-Fi and C-V2X on the shared channel.

15. The method of claim 14, wherein the Wi-Fi radio and the C-V2X radio are both external-facing with respect to the vehicle.

16. The method of claim 15, wherein:
the vehicle status information indicates that the vehicle is parked; and
the mode of operation is one in which, of the Wi-Fi radio and the C-V2X radio, only the Wi-Fi radio communicates over the shared channel.

17. The method of claim 15, wherein:
the vehicle status information indicates that the vehicle is moving;
the information regarding Wi-Fi activity on the shared channel indicates an absence of Wi-Fi communication from stations external to the vehicle; and
the mode of operation is one in which, of the Wi-Fi radio and the C-V2X radio, only the C-V2X radio communicates over the shared channel.

18. The method of claim 15, wherein:
the vehicle status information indicates that the vehicle is moving;
the information regarding Wi-Fi activity on the shared channel indicates a presence of Wi-Fi communication from one or more stations external to the vehicle; and
the mode of operation is one in which, of the Wi-Fi radio and the C-V2X radio, only the C-V2X radio communicates over the shared channel during one or more periods in which the shared channel is free of Wi-Fi transmissions from the one or more stations external to the vehicle.

19. The method of claim 18, further comprising discarding an existing C-V2X resource reservation and creating a new C-V2X resource reservation for a later time in response to detecting that the shared channel is occupied by a transmission from the one or more stations external to the vehicle.

20. The method of claim 14, wherein the Wi-Fi radio supports an internal hotspot of the vehicle.
